(19) United States
(12) Patent Application Publication
(10) Pub. No.: US 2022/0048345 A1
(43) Pub. Date: Feb. 17, 2022

(54) SWING HITCHES WITH CATCHES

(71) Applicant: Joseph Oshman, Portland, OR (US)

(72) Inventor: Joseph Oshman, Portland, OR (US)

(21) Appl. No.: 17/514,247

(22) Filed: Oct. 29, 2021

(51) Int. Cl. B60D 1/54

(52) U.S. Cl. CPC B60D 1/54

(57) ABSTRACT

Swing hitches for a vehicle and supporting cargo. The swing hitches include a fixed arm, a swing arm, and a catch. The fixed arm is operatively coupled to the vehicle. The swing arm includes a pivot end and an arc end opposite the pivot end. The pivot end is pivotally coupled to the fixed arm. The swing arm is configured to pivot horizontally between a stowed position where the arc end is proximate the fixed arm and a deployed position where the arc end is distal the fixed arm. The catch is operatively coupled to the fixed arm and to the swing arm and configured to restrict the swing arm from moving vertically relative to the fixed arm when the swing arm is in the stowed position. In some examples, the swing hitch includes a release mechanism.

### BACKGROUND

The present disclosure relates generally to swing hitches. In particular, swing hitches with catches are described.

Swing hitches provide a convenient way to haul cargo on the outside of a vehicle with a rack or other structure. The convenience of swing hitches lies in their ability to move between different configurations, which allows the rack supported by the swing hitch to be selectively moved. For example, a user may readily move the rack away from the vehicle to access the hatch of the vehicle. Further, a swing hitch makes loading or unloading cargo on the rack easier. With a swing hitch, a user may move the rack close to the vehicle in a stowed configuration to make the rack more compact and secure for travel while the vehicle is moving.

Known swing hitches are not entirely satisfactory for the range of applications in which they are employed. For example, existing swing hitches suffer from stability and wear issues, especially when loaded with cargo in a manner that results in a center of gravity of the load vertically above the hitch pivot of the swing hitch. Vertical bike racks are a common example where the center of gravity is above the hitch pivot. The center of gravity of bikes mounted on a vertical bike rack is significantly higher than the hitch pivot of the swing hitch supporting the bike rack.

When the center of gravity is above the hitch pivot, a moment arm is created that acts to twist the swing arm of the swing hitch relative to the fixed arm of the swing hitch. The twisting of the swing arm relative to the fixed arm creates excessive wear on the hitch pivot. The twisting also creates excessive wear on the toggle clamp of the swing hitch that serves to selectively restrict the swing arm from pivoting relative to the fixed arm.

In addition to increased stress on components of swing hitches, the high center of gravity tends to cause conventional swing hitches to jostle undesirably. The swing hitch jostling causes the cargo supported by the swing hitch to jostle in turn, creating unwanted noise and potentially damaging the cargo. The jostling can also cause the cargo to bang into the vehicle, potentially damaging the vehicle and/or the cargo.

It would be desirable to avoid the excessive wear suffered by conventional swing hitches due to loads exerting unmitigated twisting forces on the swing hitch. It would further be desirable to make swing hitches more stable and secure when travelling to avoid noise and potential damage from cargo jostling.

Thus, there exists a need for swing hitches that improve upon and advance the design of known swing hitches. Examples of new and useful swing hitches relevant to the needs existing in the field are discussed below.

Disclosure relevant to swing hitches is provided in U.S. Pat. No. 9,475,353B2. The complete disclosure of this patent is incorporated by reference herein for all purposes.

### SUMMARY

The present disclosure is directed to swing hitches for mounting to a vehicle and supporting cargo, such as a bike. The swing hitches include a fixed arm, a swing arm, and a catch. The fixed arm is operatively coupled to the vehicle. The swing arm includes a pivot end and an arc end opposite the pivot end. The pivot end is pivotally coupled to the fixed arm. The swing arm is configured to pivot horizontally between a stowed position where the arc end is proximate the fixed arm and a deployed position where the arc end is distal the fixed arm. The catch is operatively coupled to the fixed arm and to the swing arm and configured to restrict the swing arm from moving vertically relative to the fixed arm when the swing arm is in the stowed position. In some examples, the swing hitch includes a release mechanism.

### BRIEF DESCRIPTION OF THE DRAWINGS

FIG. 1 is a perspective view of a first embodiment of a swing hitch.

FIG. 2 is a right-side elevation view of the swing hitch shown in FIG. 1.

FIG. 3 is a rear elevation view of the swing hitch shown in FIG. 1.

FIG. 4 is a rear perspective close-up view of a second catch.

FIG. 5 is a front elevation view of the swing hitch shown in FIG. 1.

FIG. 6 is a bottom view of the swing hitch shown in FIG. 1.

FIG. 7 is a top view of the swing hitch shown in FIG. 1.

FIG. 8 is a top view of the swing hitch shown in FIG. 1 in a deployed configuration.

FIG. 9 is a right-side elevation view of the swing hitch shown in FIG. 1 in a deployed configuration.

FIG. 10 is a perspective view of a second embodiment of a swing hitch including a projection with an adjustment mechanism.

### DETAILED DESCRIPTION

The disclosed swing hitches will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various swing hitches are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Swing Hitches with Catches

With reference to the figures, swing hitches with catches will now be described. The swing hitches discussed herein function to moveably support cargo from a vehicle.

The reader will appreciate from the figures and description below that the presently disclosed swing hitches address many of the shortcomings of conventional swing hitches. For example, the novel swing hitches described herein avoid the excessive wear suffered by conventional swing hitches by mitigating twisting forces on the swing hitch. The novel swing hitches described below are more stable and secure when travelling than conventional swing hitches. As a result of being more stable and secure, the novel swing hitches described in this document reduce the noise and potential damage resulting from cargo jostling suffered by existing swing hitches.

Contextual Details

Ancillary features relevant to the swing hitches described herein will first be described to provide context and to aid the discussion of the swing hitches.

Vehicle

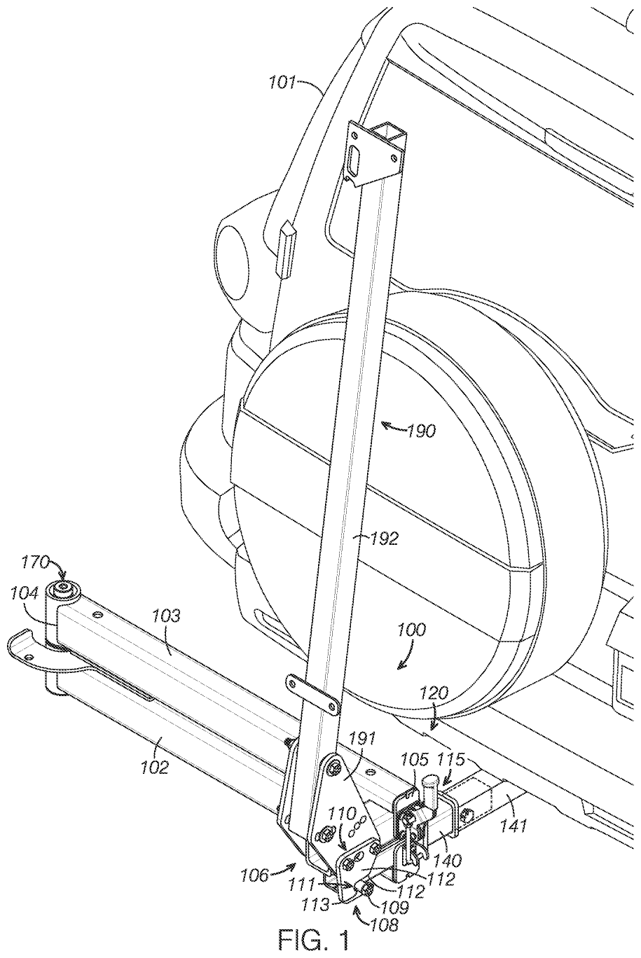

The swing hitches discussed below are configured to mount to a vehicle. FIG. 1 depicts a vehicle 101 to which swing hitch 100 is mounted. Vehicle 101 includes a towing receiver 141 and may be any currently known or later developed type of vehicle. The reader will appreciate that a variety of vehicle types exist and could be used in place of the vehicle shown in FIG. 1. In addition to the types of vehicles existing currently, it is contemplated that the swing hitches described herein could be used with new types of vehicles developed in the future.

Cargo Carrier

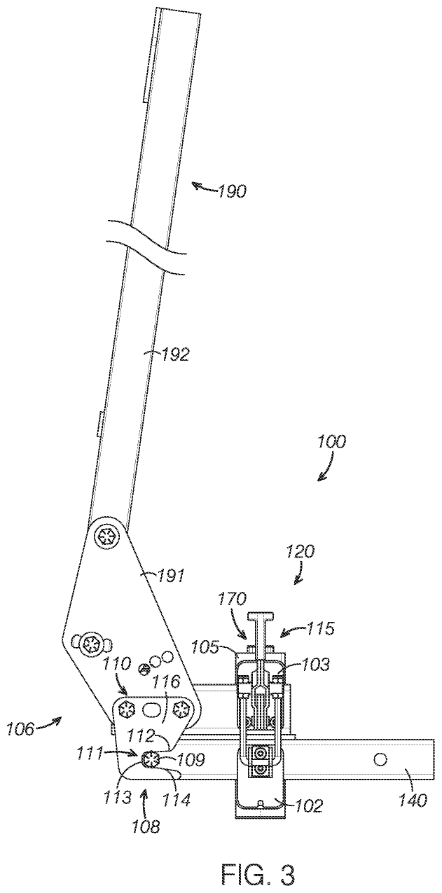

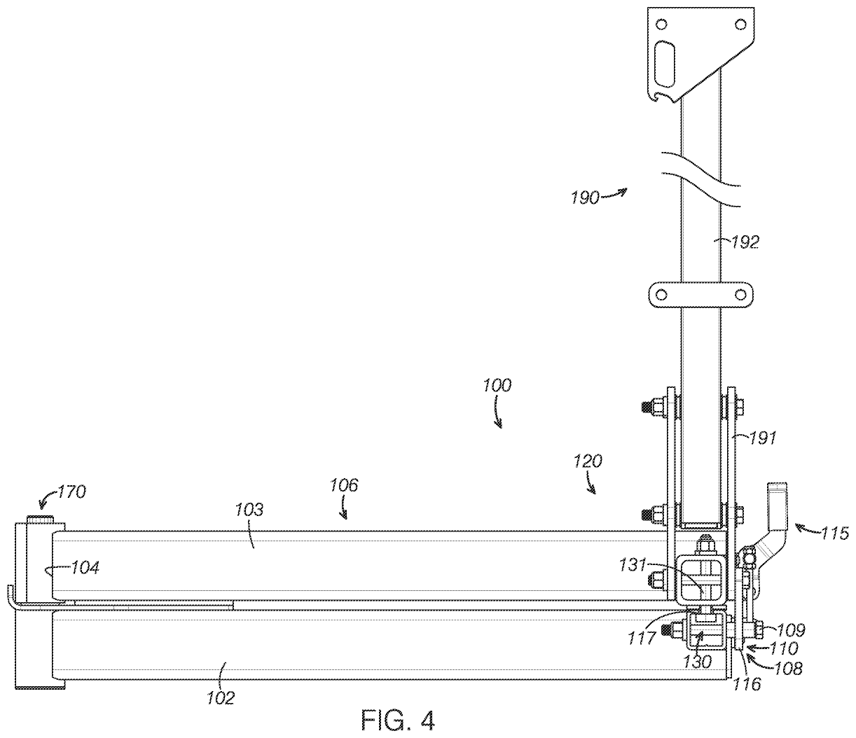

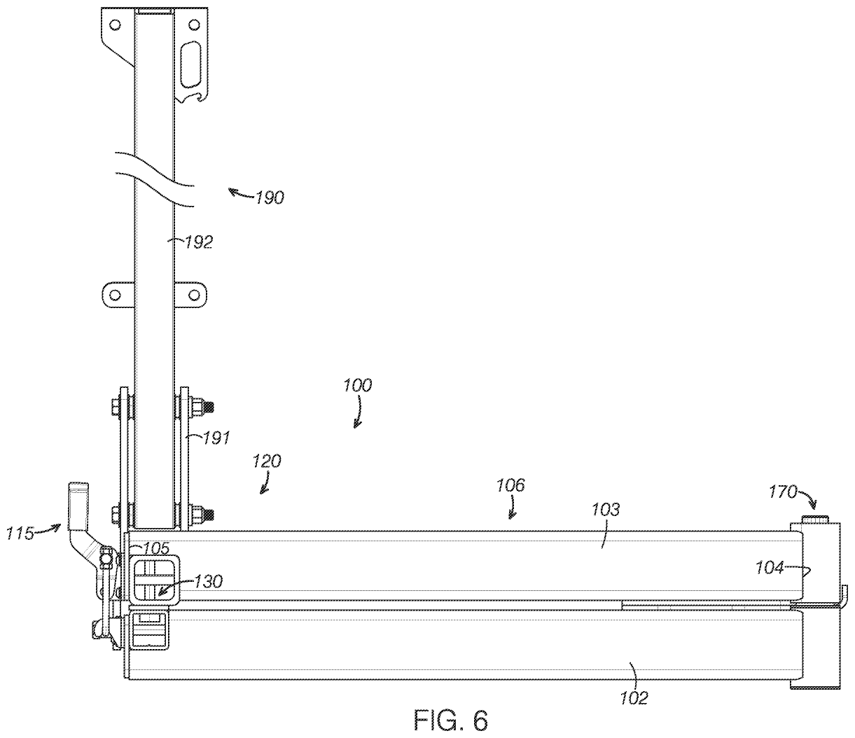

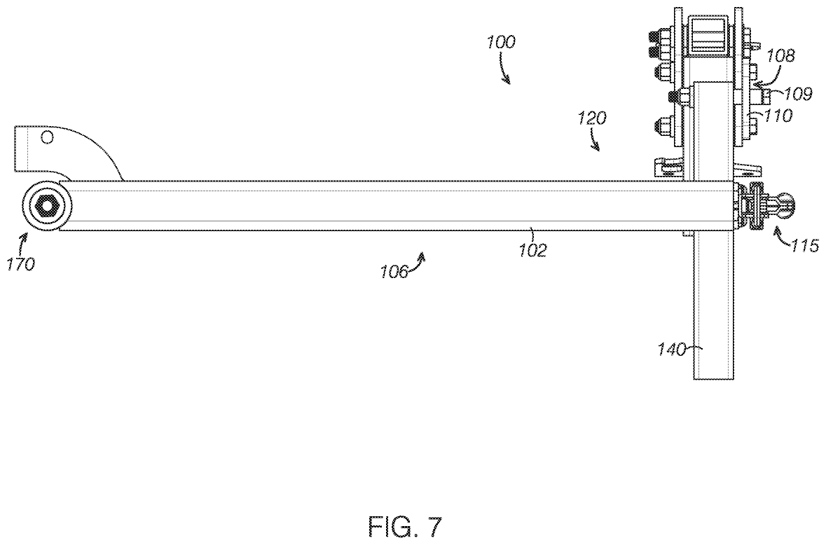

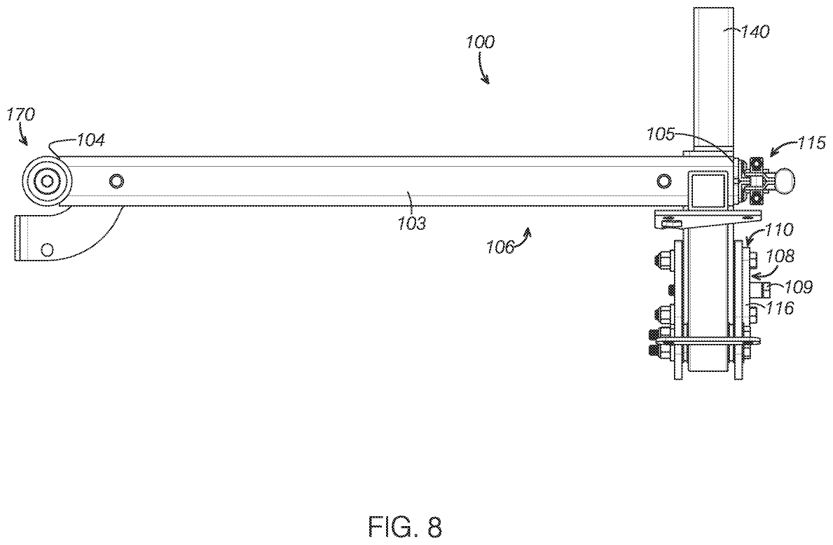

The swing hitches discussed in this document may support a variety of cargo carriers, including bike racks, spare tires, and cargo trays and boxes. FIGS. 1-9 depict a bike rack 190 as one example of a bike rack that may be supported by swing hitches. The reader should understand that the swing hitches could support other types of bike racks as well. Bike rack 190 includes a bracket 191 and a spine 192. Bracket 191 couples spine 192 to swing hitch 100. Spine 192 supports bikes or other cargo.

The bike rack or cargo carrier may be any currently known or later developed type of bike rack or other cargo carrier. Bike rack 190 is just one example of a suitable cargo carrier and other cargo carriers could be supported by swing hitch 100 instead.

### Swing Hitch Embodiment One

With reference to FIGS. 1-9, a swing hitch 100 will now be described as a first example of a swing hitch. Swing hitch 100 mounts to a vehicle 101 and supports cargo, such as a bike. As shown in FIGS. 1-9, swing hitch 100 includes a fixed arm 102, a swing arm 103, a first catch 108, a second catch 130, and a release mechanism 115. In other examples, the swing hitch includes fewer components than depicted in the figures, such as including only a single catch instead of two catches. In certain examples, the swing hitch includes additional or alternative components than depicted in the figures.

The size and shape of the swing hitch may be varied as needed for a given application. In some examples, the swing hitch is larger relative to the other components than depicted in the figures. In other examples, the swing hitch is smaller relative to the other components than depicted in the figures. Further, the reader should understand that the swing hitch and the other components may all be larger or smaller than described herein while maintaining their relative proportions.

Fixed Arm

The role of fixed arm 102 is to support swing arm 103, first catch 108, second catch 130, and other components of swing hitch 100. The reader can see in FIG. 1 that fixed arm 102 is operatively coupled to vehicle 101.

In particular, fixed arm 102 couples to vehicle 101 via a tongue 140 extending from fixed arm 102. Tongue 140 inserts into towing receiver 141 of vehicle 101. The size and shape of tongue 140 complements the size and shape of towing receiver 141.

In the present example, tongue 140 is a tubular member with a square cross section. However, the shape of the tongue may be adapted to be different than the specific examples shown in the figures to suit a given application. In other examples, the cross section of the tongue is circular, oval, triangular, another regular polygon, or an irregular shape.

The tongue may be any currently known or later developed type of tongue or trailer coupler. The reader will appreciate that a variety of tongue or trailer coupler types exist and could be used in place of the tongues shown in the figures. In addition to the types of tongues or trailer couplers existing currently, it is contemplated that the tongues described herein could incorporate new types of tongues or trailer couplers developed in the future.

In the present example, tongue 140 is comprised of steel. However, the tongue may be composed of any currently known or later developed material suitable for the applications described herein for which it is used. Suitable materials include metals, polymers, wood, and composite materials.

The size and shape of the fixed arm may be varied as needed for a given application. In some examples, the fixed arm is larger relative to the other components than depicted in the figures. In other examples, the fixed arm is smaller relative to the other components than depicted in the figures. Further, the reader should understand that the fixed arm and the other components may all be larger or smaller than described herein while maintaining their relative proportions.

In the present example, fixed arm 102 is composed of steel. However, the fixed arm may be composed of any currently known or later developed material suitable for the applications described herein for which it is used. Suitable materials include metals, polymers, ceramics, wood, and composite materials.

Swing Arm

Swing arm 103 functions to selectively move to make accessing cargo supported on swing hitch 100 or accessing vehicle 101 behind swing hitch 100 more convenient. As shown in FIGS. 1, 3, and 8, swing arm 103 includes a pivot end 104 and an arc end 105. The reader can see in FIGS. 1, 3, and 8 that pivot end 104 is pivotally coupled to fixed arm 102 to define a hitch pivot 170. Arc end 105 is opposite pivot end 104.

With reference to FIGS. 1, 3, and 8, swing arm 103 is configured to pivot horizontally between a stowed position 106 and a deployed position 107. In stowed position 106, arc end 105 is proximate fixed arm 102. In deployed position 107, arc end 105 is distal fixed arm 102.

The size and shape of the swing arm may be varied as needed for a given application. In some examples, the swing arm is larger relative to the other components than depicted in the figures. In other examples, the swing arm is smaller relative to the other components than depicted in the figures. Further, the reader should understand that the swing arm and the other components may all be larger or smaller than described herein while maintaining their relative proportions.

In the present example, swing arm 103 is composed of steel. However, the swing arm may be composed of any currently known or later developed material suitable for the applications described herein for which it is used. Suitable materials include metals, polymers, ceramics, wood, and composite materials.

Catches

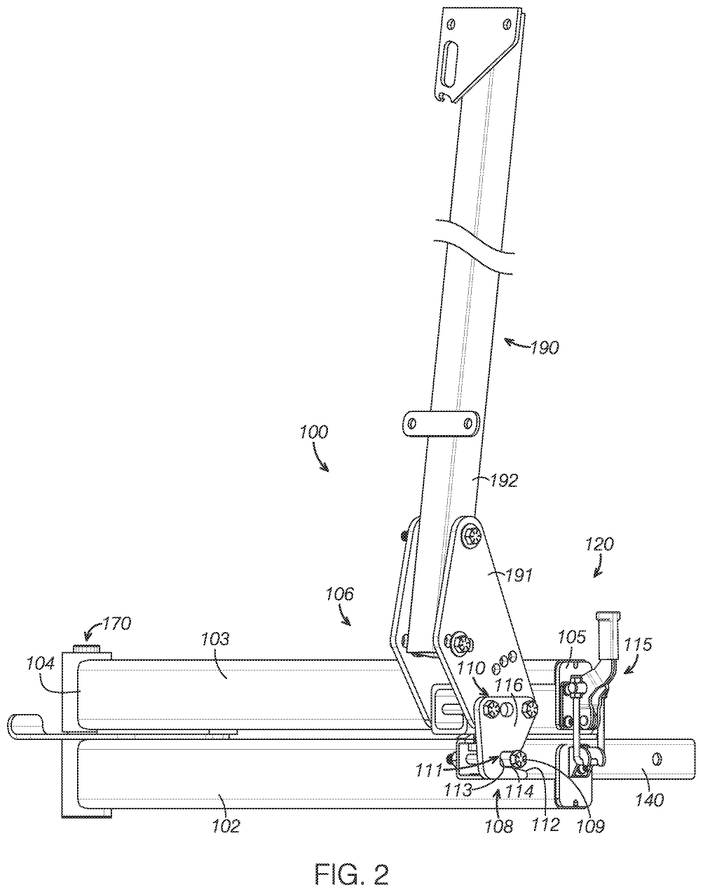

First catch 108 and second catch 130 function to restrict swing arm 103 from moving vertically relative to fixed arm 102 when swing arm 103 is in stowed position 106. As depicted in FIGS. 1-9, first catch 108 and second catch 130 are each operatively coupled to fixed arm 102 and to swing arm 103. As shown in FIGS. 2, 4, 8, and 9, first catch 108 and second catch 130 are each horizontally spaced from release mechanism 115 in the direction that swing arm 103 pivots relative to fixed arm 102.

With reference to FIGS. 1, 2, and 9, first catch 108 includes a first projection 109 and a receiver 110. As shown in FIG. 4, second catch 130 includes a second projection 131 and a slot 117. The components of first catch 108 and second catch 130 are described in the sections below.

The number of catches in the swing hitch may be selected to meet the needs of a given application. The reader should appreciate that the number of catches may be different in other examples than is shown in the figures. For instance, some swing hitch examples include additional or fewer catches than described in the present example. Some swing hitch examples include a single catch rather than two catches as depicted in FIGS. 1-9.

The catch may be any currently known or later developed type of catch. The reader will appreciate that a variety of catch types exist and could be used in place of the catch shown in the figures. In addition to the types of catches existing currently, it is contemplated that the swing hitches described herein could incorporate new types of catches developed in the future.

The size and shape of the catch may be varied as needed for a given application. In some examples, the catch is larger relative to the other components than depicted in the figures. In other examples, the catch is smaller relative to the other components than depicted in the figures. Further, the reader should understand that the catch and the other components may all be larger or smaller than described herein while maintaining their relative proportions.

In the present example, the catches are composed of steel. However, the catches may be composed of any currently known or later developed material suitable for the applications described herein for which it is used. Suitable materials include metals, polymers, ceramics, wood, and composite materials.

Projections

The projection may be any currently known or later developed type of projection. The reader will appreciate that a variety of projection types exist and could be used in place of the projections shown in the figures. In addition to the types of projections existing currently, it is contemplated that the swing hitches described herein could incorporate new types of projections developed in the future.

The size and shape of the projections may be varied as needed for a given application. In some examples, one or both of the projections is larger relative to the other components than depicted in the figures. In other examples, one or both of the projection is smaller relative to the other components than depicted in the figures. Further, the reader should understand that the projections and the other components may all be larger or smaller than described herein while maintaining their relative proportions.

In the present example, the projections are each composed of metal. However, the projection may be composed of any currently known or later developed material suitable for the applications described herein for which it is used. Suitable materials include metals, polymers, ceramics, wood, and composite materials.

First Projection

First projection 109 of first catch 108 functions to engage receiver 110 to restrict swing arm 103 from moving vertically relative to fixed arm 102. The reader can see in FIGS. 1, 2, 8, and 9 that first projection 109 is connected to fixed arm 102 via mechanically fastening to tongue 140 of fixed arm 102.

Receiver

Receiver 110 functions to receive first projection 109. As shown in FIGS. 1, 2, and 9, receiver 110 is mounted to swing arm 103. The reader can see in FIGS. 1, 2, and 9 that receiver 110 is complementarily configured with first projection 109. As depicted in FIGS. 1, 2, and 9, receiver 110 includes a plate 116 defining a channel 111. As shown in FIGS. 1 and 2, receiver 110 receives first projection 109 when swing arm 103 pivots to a rest position 120 overlying fixed arm 102.

The size and shape of the receiver may be varied as needed for a given application. In some examples, the receiver is larger relative to the other components than depicted in the figures. In other examples, the receiver is smaller relative to the other components than depicted in the figures. Further, the reader should understand that the receiver and the other components may all be larger or smaller than described herein while maintaining their relative proportions.

In the present example, receiver 110 is composed of steel. However, the receiver may be composed of any currently known or later developed material suitable for the applications described herein for which it is used. Suitable materials include metals, polymers, ceramics, wood, and composite materials.

Channel

The role of channel 111 is to receive first projection 109. As depicted in FIGS. 1, 2, and 9, channel 111 is complementarily configured with first projection 109. The reader can see in FIGS. 1, 2, and 9 that channel 111 defines an entrance 112, a terminal end 113, and an inclined surface 114. Inclined surface 114 extends between entrance 112 and terminal end 113.

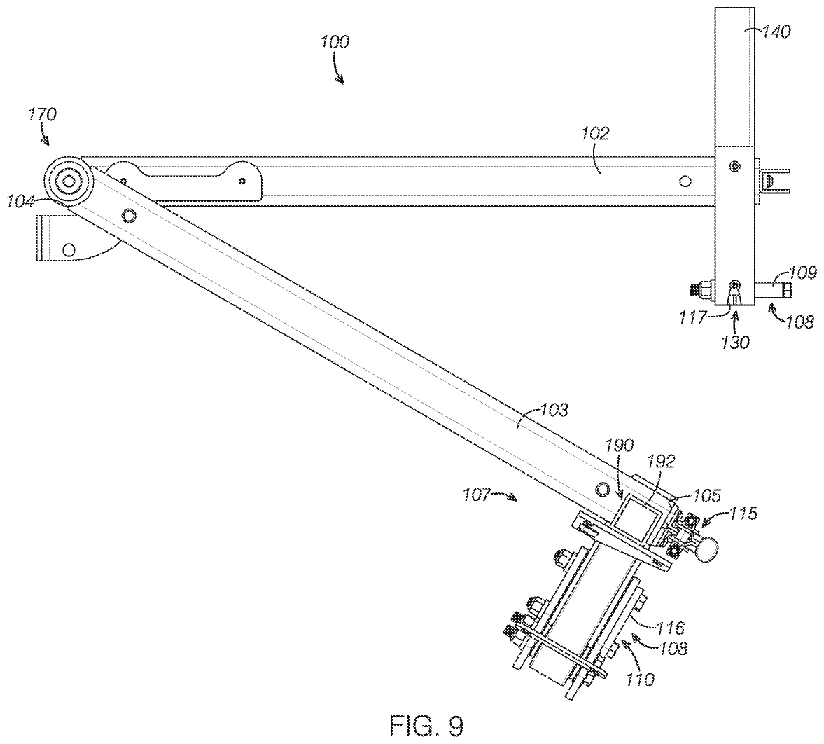

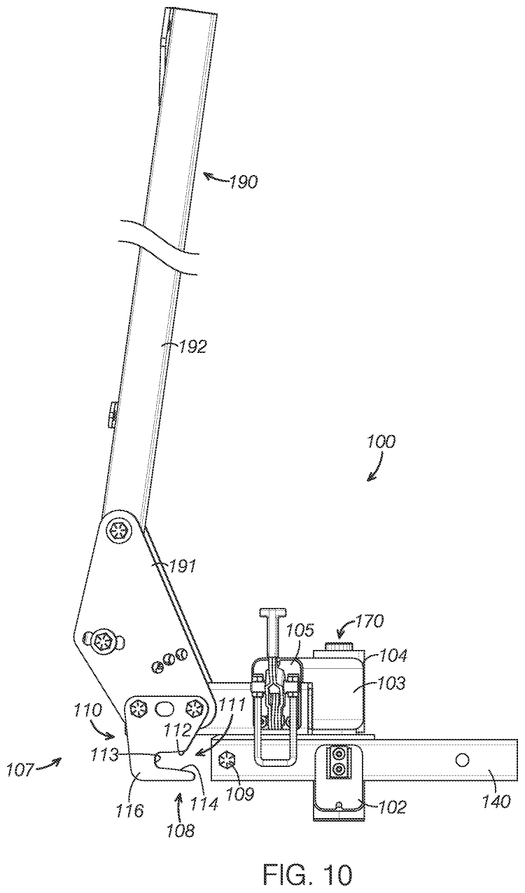

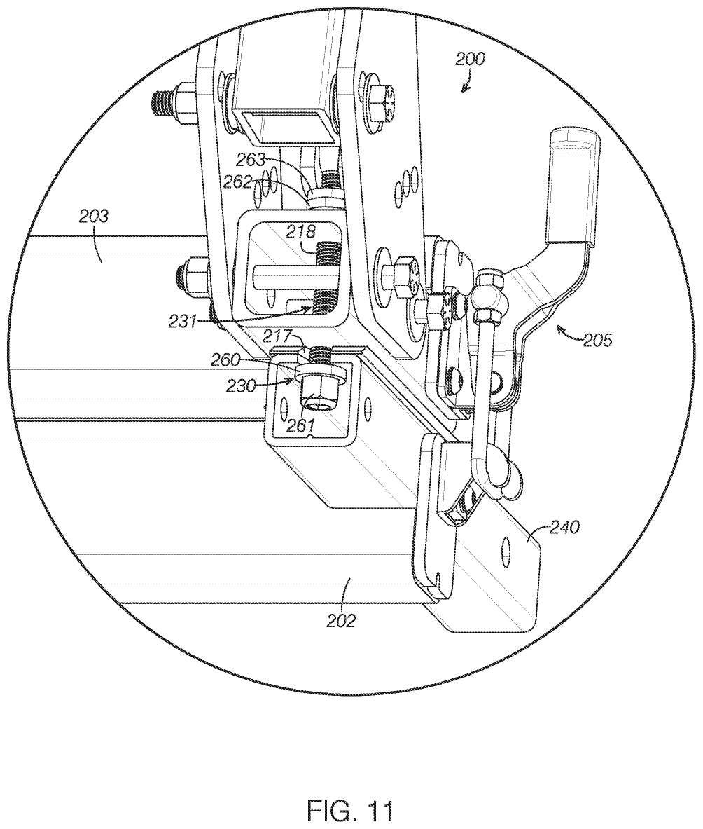

As shown in in FIGS. 1, 2, and 9, terminal end 113 is spaced from entrance 112. As depicted in FIG. 9, terminal end 113 has a terminal end height corresponding to the spacing of channel 111 proximate terminal end 113. Entrance 112 has an entrance height corresponding to the spacing of channel 111 proximate entrance 112. In the present example, as can be seen in FIG. 9, the entrance height is greater than the terminal end height.

Inclined surface 114 extends from entrance 112 to terminal end 113 and abuts projection 109 from below to stabilize swing arm 103 by restricting swing arm 103 from moving away from fixed arm 102. First projection 109 is disposed proximate terminal end 113 of receiver 110 when swing arm 103 is in stowed position 106, but does not contact terminal end 113. With reference to FIGS. 1, 2, and 9, channel 111 and projection 109 cooperate to cause swing arm 103 and fixed arm 102 to abut each other when projection 109 is disposed in channel 111.

The size and shape of the channel may be varied as needed for a given application. In some examples, the channel is larger relative to the other components than depicted in the figures. In other examples, the channel is smaller relative to the other components than depicted in the figures. Further, the reader should understand that the channel and the other components may all be larger or smaller than described herein while maintaining their relative proportions.

Second Projection

As shown in FIG. 4, second projection 131 of second catch 130 also functions to restrict swing arm 103 from moving vertically relative to fixed arm 102. With reference to FIG. 4, second projection 131 is mechanically coupled to swing arm 103. The reader can see in FIG. 4 that second projection 131 includes a shaft 118 and a head 119. In the present example, second projection is a bolt, but may be configured differently in other examples.

Head

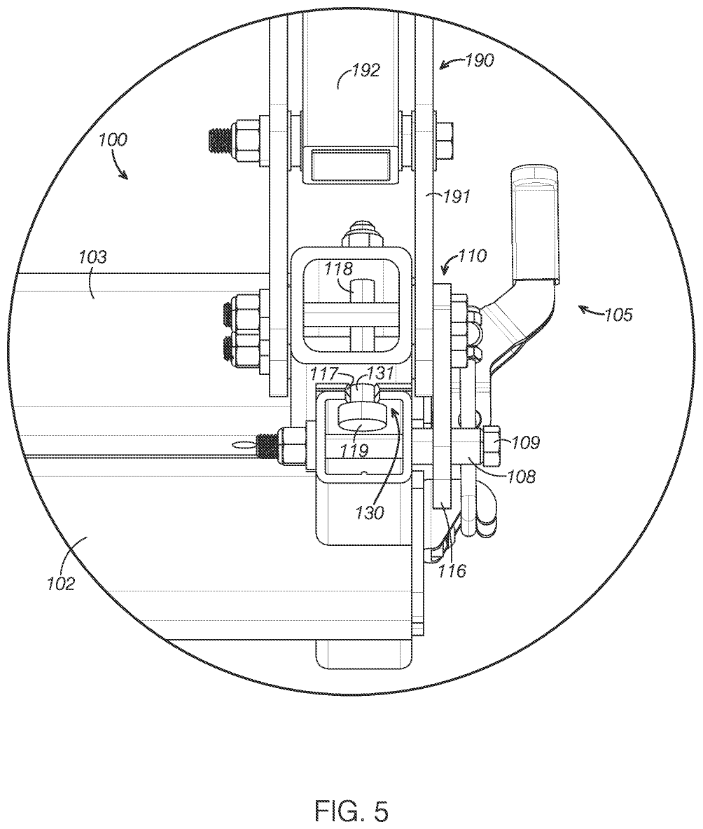

As shown in FIG. 5, head 119 abutting slot 117 opposite swing arm 103 restricts swing arm 103 from moving away from fixed arm 102. With reference to FIG. 5, head 119 is mounted to shaft 118 and is wider than shaft 118.

Slot 117 functions to receive second projection 131. The reader can see in FIGS. 4 and 5 that slot 117 is formed in tongue 140 of fixed arm 102 in a position to receive second projection 131. As depicted in FIG. 5, slot 117 is sized to receive shaft 118 and to block head 119 from moving through slot 117. With reference to FIG. 5, slot 117 is disposed between swing arm 103 and head 119 when second projection 131 is disposed in slot 117.

The size and shape of the slot may be varied as needed for a given application. In some examples, the slot is larger relative to the other components than depicted in the figures. In other examples, the slot is smaller relative to the other components than depicted in the figures. Further, the reader should understand that the slot and the other components may all be larger or smaller than described herein while maintaining their relative proportions.

Release Mechanism

As shown in FIGS. 1-9, release mechanism 115 is configured to selectively restrict swing arm 103 from pivoting relative to fixed arm 102. In the present example, release mechanism 115 is configured to selectively restrict swing arm 103 from pivoting relative to fixed arm 102 when swing arm 103 is in stowed position 106. As shown in FIGS. 1-9, release mechanism 115 is a toggle clamp.

The release mechanism may be any currently known or later developed type of release mechanism. The reader will appreciate that a variety of release mechanism types exist and could be used in place of the release mechanism shown in the figures. In addition to the types of release mechanisms existing currently, it is contemplated that the swing hitches described herein could incorporate new types of release mechanisms developed in the future.

The number of release mechanisms in the swing hitch may be selected to meet the needs of a given application. The reader should appreciate that the number of release mechanisms may be different in other examples than is shown in the figures. For instance, some swing hitch examples include additional or fewer release mechanisms than described in the present example.

The size and shape of the release mechanism may be varied as needed for a given application. In some examples, the release mechanism is larger relative to the other components than depicted in the figures. In other examples, the release mechanism is smaller relative to the other components than depicted in the figures. Further, the reader should understand that the release mechanism and the other components may all be larger or smaller than described herein while maintaining their relative proportions.

### Additional Embodiments

With reference to the figures not yet discussed, the discussion will now focus on an additional swing hitch embodiment. The additional embodiment includes many similar or identical features to swing hitch 100. Thus, for the sake of brevity, each feature of the additional embodiment below will not be redundantly explained. Rather, key distinctions between the additional embodiment and swing hitch 100 will be described in detail and the reader should reference the discussion above for features substantially similar between the different swing hitch examples.

### Second Embodiment

Turning attention to FIG. 11, a second example of a swing hitch, swing hitch 200, will now be described. As can be seen in FIG. 11, swing hitch 200 includes a fixed arm 202, a swing arm 203, a catch 230, and a release mechanism 215.

Catch 230 is partially defined in a tongue 240 of fixed arm 202 and is coupled to swing arm 203. Catch 230 includes a slot 217 defined in tongue 240 of fixed arm 202 and a projection 231. A distinction between swing hitch 200 and swing hitch 100 is that catch 230 includes an adjustable projection 231 whereas second projection 131 in second catch 130 is not adjustable in length.

As shown in FIG. 11, projection 231 includes a threaded shaft 218, a head washer 260, a head nut 261, a foot washer 262, and a foot nut 263. The space between head washer 260 and foot washer 262 is defined herein as an effective length of threaded shaft 218.

The effective length of threaded shaft 218 is adjustable. The effective length may be adjusted by tightening foot nut 263 at different positions along the length of threaded shaft 218 to secure foot washer 262 at different positions along the length of threaded shaft 218. The space between head washer 260 and foot washer 262 will vary according to the position of foot washer 262 on threaded shaft 218.

The effective length of threaded shaft 218 defines the spacing between fixed arm 202 and swing arm 203 when projection 231 is disposed in slot 217. As shown in FIG. 11, slot 217 is disposed between head washer 260 and swing arm 203 when projection 231 is disposed within slot 217. Catch 230 restricts swing arm 203 from moving vertically upwards because projection 231 is secured to swing arm 203 and blocked from moving upwards by head washer 260 abutting tongue 240 around slot 217. Adjusting the effective length of projection 231 adjusts the range of upward vertical movement permitted by catch 230.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A swing hitch for a vehicle, comprising:
a fixed arm operatively coupled to the vehicle;
a swing arm including a pivot end and an arc end opposite the pivot end;
wherein the pivot end is pivotally coupled to the fixed arm;
wherein the swing arm is configured to pivot horizontally between a stowed position where the arc end is proximate the fixed arm and a deployed position where the arc end is distal the fixed arm; and
a catch operatively coupled to the fixed arm and to the swing arm and configured to restrict the swing arm from moving vertically relative to the fixed arm when the swing arm is in the stowed position.

2. The swing hitch of claim 1, wherein the catch includes:
a projection operatively connected to the fixed arm; and
a receiver mounted to the swing arm and configured to receive the projection.

3. The swing hitch of claim 2, wherein the receiver is complementarily configured with the projection.

4. The swing hitch of claim 3, wherein the receiver defines a channel.

5. The swing hitch of claim 4, wherein the channel defines:
an entrance;
a terminal end spaced from the entrance; and
an inclined surface extending from the entrance to the terminal end to guide the projection towards the terminal end.

6. The swing hitch of claim 5, wherein:
the entrance has an entrance height;
the terminal end has a terminal end height; and
the entrance height is greater than the terminal end height.

7. The swing hitch of claim 5, wherein the projection is disposed proximate the terminal end when the swing arm is in the stowed position.

8. The swing hitch of claim 7, further comprising a release mechanism configured to selectively restrict the swing arm from pivoting relative to the fixed arm.

9. The swing hitch of claim 8, wherein the release mechanism is configured to selectively restrict the swing arm from pivoting relative to the fixed arm when the swing arm is in the stowed position.

10. The swing hitch of claim 2, wherein:
the receiver includes a plate defining a channel; and
the channel is complementarily configured with the projection to receive the projection.

11. The swing hitch of claim 2, wherein the channel and the projection cooperate to cause the swing arm and the fixed arm to abut each other when the projection is disposed in the channel.

12. The swing hitch of claim 1, further comprising a release mechanism configured to selectively restrict the swing arm from pivoting relative to the fixed arm

13. The swing hitch of claim 12, wherein the catch is horizontally spaced from the release mechanism in the direction that the swing arm pivots relative to the fixed arm.

14. The swing hitch of claim 1, wherein catch includes:
a projection mechanically coupled to the swing arm; and
a slot formed in the fixed arm in a position to receive the projection.

15. The swing hitch of claim 14, wherein the projection includes:
a shaft; and
a head mounted to the shaft and wider than the shaft.

16. The swing hitch of claim 15, wherein the slot is sized to receive the shaft and to block the head from moving through the slot.

17. The swing hitch of claim 16, wherein the slot is disposed between the swing arm and the head when the projection is disposed in the slot.

18. The swing hitch of claim 17, wherein the head abutting the slot opposite the swing arm restricts the swing arm from moving away from the fixed arm.

19. A catch for a swing hitch having a fixed arm and a swing arm pivotally coupled to the fixed arm to pivot horizontally about the fixed arm, the catch comprising:
a projection operatively connected to the fixed arm; and
a receiver mounted to the swing arm and configured to receive the projection;
wherein the catch is configured to restrict the swing arm from moving vertically relative to the fixed arm when the receiver receives the projection.

20. The swing hitch of claim 19, wherein the receiver receives the projection when the swing arm pivots to a rest position overlying the fixed arm.
